(19) United States
(12) Patent Application Publication
(10) Pub. No.: US 2016/0135384 A1
(43) Pub. Date: May 19, 2016

(54) SPROUTED SEED GRAIN GROWING AND HARVESTING APPARATUS

(71) Applicant: SPROUTING WORKS LLC, Millersburg, PA (US)

(72) Inventors: Dennis SOUDER, Millersburg, PA (US); Ivan W. MARTIN, Millersburg, PA (US)

(21) Appl. No.: 14/540,539

(22) Filed: Nov. 13, 2014

(51) Int. Cl. A01G 9/12; A01G 7/00; A01G 9/24; A01G 1/00

(52) U.S. Cl. CPC A01G 9/12; A01G 1/001; A01G 7/00; A01G 9/24

(57) ABSTRACT

An apparatus for growing and harvesting a tangled mass composed of sprouted seed grain, including a plurality of overlying movable (relative to the frame), substantially planar surfaces having a length, each surface movable (relative to the frame) between a first position and a second position, each surface configured to receive a layer of seed grain that is permitted to grow for a predetermined period of time on each surface in the first position, the layer of seed grain becoming a continuous tangled mass of sprouted seed grain. After the predetermined period of time, a surface of the plurality of surfaces is moved to the second position, such that the mass associated with the moved surface is at least substantially removable from the moved surface due to gravity.

### FIELD OF THE DISCLOSURE

The present disclosure generally relates to crop growing systems. The present disclosure additionally relates to a sprouted seed grain growing system.

### BACKGROUND OF THE DISCLOSURE

Producers of livestock are continually looking for ways to increase yield (e.g., milk, eggs) and/or quality of meat for consumption. Even for animals grazing on pastures, it has been determined that plants, such as grasses, provide decreased nutritional value as the plant grows. In response, a number of livestock producers have begun feeding their animals newly sprouted seed grain to bolster the level of nutrition contained in the diets of their animals. One recommended feeding regimen includes providing newly sprouted seed grain at a daily feed rate of two percent of an animal's live weight per day to achieve beneficial results.

Systems are available to produce the newly sprouted seed grain, utilizing small trays for the growing surface on which a layer of seed grain sprouts for harvesting, typically in one week or less. The trays are small, typically limited to a “footprint” of several square feet in area, due to the weight of sprouted seed grain that is harvested, which contains a high level of moisture, and which forms a tangled mass of interconnected roots that is difficult to separate into smaller pieces. Manually maintained systems require a significant amount of physical labor, including spreading seed grain in trays, placing the trays in a multi-layered rack, advancing (pushing) the trays along the rack, emptying the trays (harvesting the sprouted seed grain) and then washing the trays before repeating this continuous process. While this arrangement may be manageable for producers having a small number of livestock to maintain, a significant amount of producers have a sufficient number of livestock for which a daily production of 1,000 to 2,000 pounds or more of sprouted seed grain is required. A daily basis, lifting, moving and distributing 2,000 pounds of dense masses of wet sprouted seed grain manually is not practical.

While automated systems are available, utilizing similarly sized trays for harvesting the sprouted seed grain as utilized with manual systems, such automated systems are extremely expensive and thus, are not available to most livestock producers.

Accordingly, there is a need for a cost effective, compact system that can significantly increase the rate of production of sprouted seed grain while significantly reducing most of the more physically demanding tasks associated with such production.

### SUMMARY OF THE DISCLOSURE

An exemplary embodiment of the present disclosure is directed to an apparatus for growing and harvesting a tangled mass composed of sprouted seed grain, including a plurality of overlying movable (relative to the frame), substantially planar surfaces having a length, each surface movable (relative to the frame) between a first position and a second position, each surface configured to receive a layer of seed grain that is permitted to grow for a predetermined period of time on each surface in the first position, the layer of seed grain becoming a continuous tangled mass of sprouted seed grain. After the predetermined period of time, a surface of the plurality of surfaces is moved to the second position, such that the mass associated with the moved surface is at least substantially removable from the moved surface due to gravity.

A further embodiment of the present disclosure is directed to a method for growing and harvesting a mass composed of sprouted seed grain, including providing a device as claimed in claim 1 and depositing a layer of seed grain onto each surface. The method further includes controllably applying water onto each layer of seed grain and removing from the device each mass removed from its corresponding surface in the second position.

A yet further embodiment of the present disclosure is directed to an apparatus for growing and harvesting a tangled mass composed of sprouted seed grain, including a plurality of overlying movable (relative to the frame), substantially planar surfaces having a length. Each movable surface is rotatable about an axis extending along the length of the surface between a first position and a second position, each surface configured to receive a layer of seed grain that is permitted to grow for a predetermined period of time on each surface in the first position, the layer of seed grain becoming a continuous tangled mass of sprouted seed grain. After the predetermined period of time, a surface of the plurality of surfaces is moved to the second position, such that the mass associated with the moved surface is at least substantially removable from the moved surface due to gravity.

Further aspects of the method and system are disclosed herein. The features as discussed above, as well as other features and advantages of the present disclosure will be appreciated and understood by those skilled in the art from the following detailed description and drawings.

### BRIEF DESCRIPTION OF THE DRAWINGS

FIG. 1 illustrates an upper perspective view of an apparatus according to an embodiment of the disclosure.

FIG. 2 illustrates a partial cutaway, upper perspective view of the apparatus of FIG. 1 according to an embodiment of the disclosure.

FIG. 3 illustrates an upper perspective view of a frame of an apparatus according to an embodiment of the disclosure.

FIG. 4 illustrates an upper perspective view of the frame of FIG. 3 and support surfaces arranged in a first position according to an embodiment of the disclosure.

FIG. 5 illustrates an upper perspective view of the frame of FIG. 3 and a support surface arranged in a second position according to an embodiment of the disclosure.

FIG. 6 illustrates an enlarged, reverse upper perspective view of region 5 taken from FIG. 4 according to an embodiment of the disclosure.

FIG. 7 illustrates a side view of the frame and support surfaces of FIG. 4 according to an embodiment of the disclosure.

FIG. 8 illustrates a side view of the frame and support surfaces of FIG. 5 according to an embodiment of the disclosure.

FIG. 9 illustrates an upper perspective view of a seed deposition device according to an embodiment of the disclosure.

FIG. 10 illustrates an enlarged upper perspective view of the seed deposition device of FIG. 9 according to an embodiment of the disclosure.

FIG. 11 illustrates an upper perspective view of a watering device according to an embodiment of the disclosure.

FIG. 12 illustrates an enlarged, partial upper perspective view of the watering device of FIG. 11 according to an embodiment of the disclosure.

FIG. 13 illustrates an upper perspective view of an evacuator according to an embodiment of the disclosure.

### DETAILED DESCRIPTION OF THE DISCLOSURE

Specific embodiments of apparatus and methods for growing and harvesting a tangled mass composed of sprouted seed grain according to the disclosure are described below with reference to the drawings.

This disclosure contains improvements to Applicant's sprouted seed grain growing and harvesting apparatus and method, issuing as U.S. Pat. No. 8,627,598 that is incorporated by reference in its entirety.

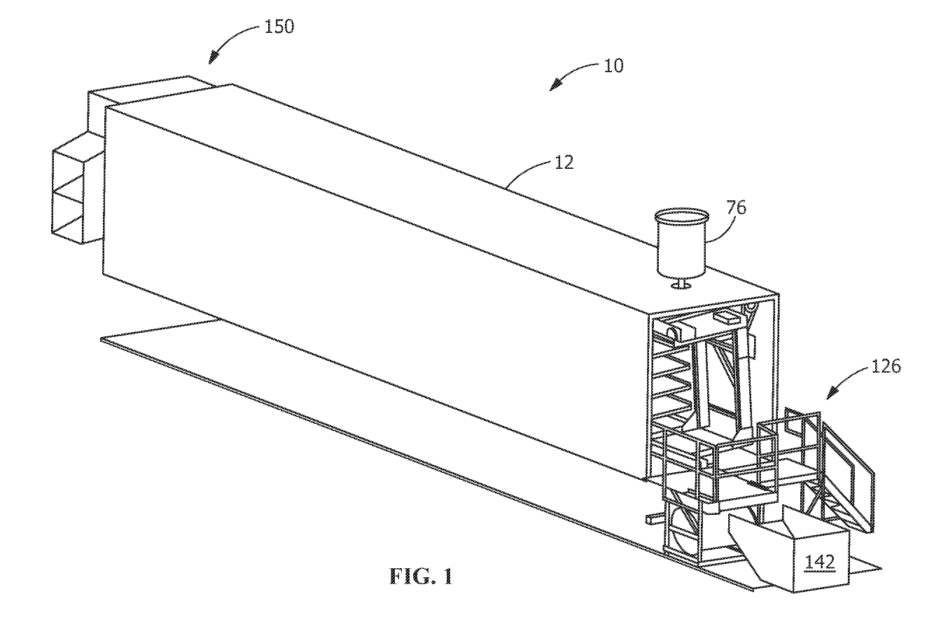

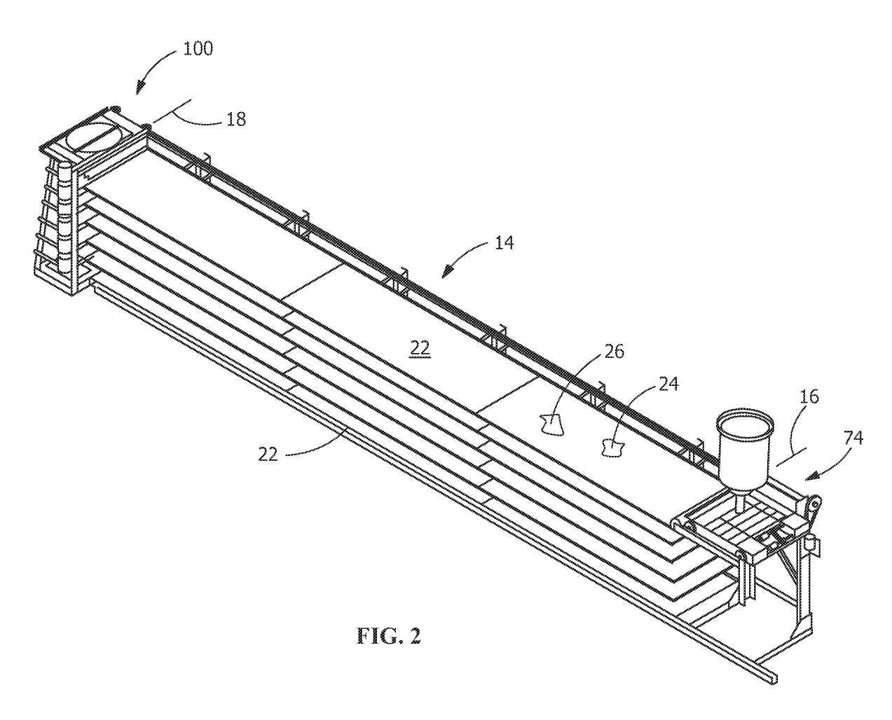

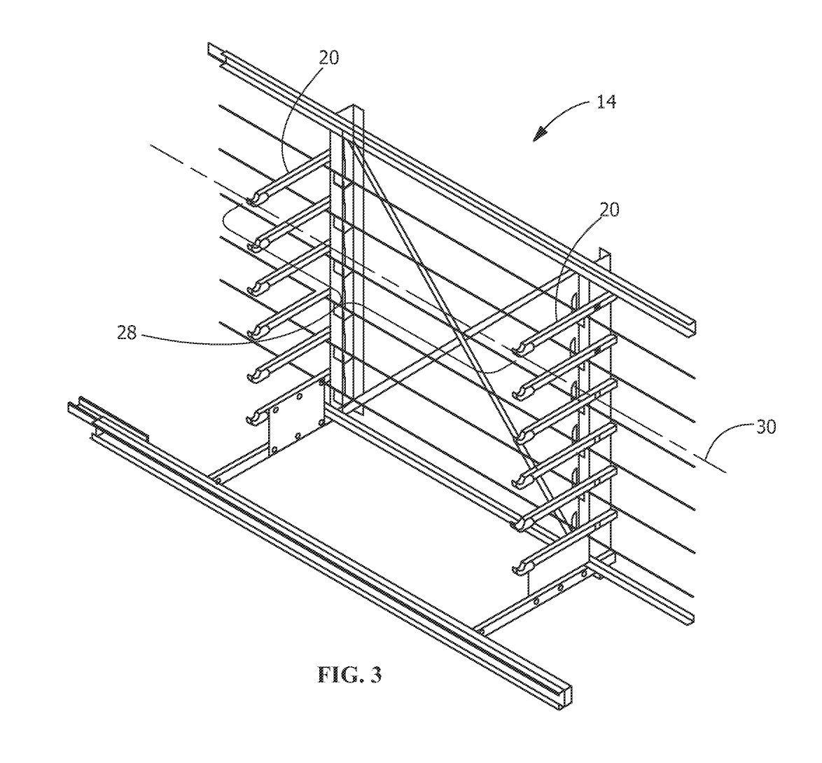

FIG. 1 shows an apparatus 10 for growing and harvesting a tangled mass composed of sprouted seed grain. Optionally, as further shown in FIG. 1, apparatus 10 is substantially positioned inside of a semi-trailer 12, such as a reefer trailer commonly utilized to transport cargo requiring refrigeration. As shown in FIG. 2, apparatus 10 includes a frame 14 longitudinally extending between opposed ends 16, 18. As further shown in FIG. 3, frame 12 includes a plurality of cantilevered frame portions 20 extending transverse to the longitudinal length of frame 14 extending between ends 16, 18 (FIG. 2) for structurally carrying or supporting corresponding sheets or substantially planar surfaces 22 for receiving a layer 24 of seed grain (FIG. 2). After a predetermined period of time has passed, such as between about 3 days and about 8 days, depending upon the type of seed grain utilized, such as barley seed or any suitable seed grain, layer 24 of seed grain becomes a tangled mass 26 composed of sprouted seed grain. In one embodiment, the predetermined period of time is sufficient to facilitate at least a portion of a process referred to as “malting,” which converts a seed grain such as barley into malt, such as for use in brewing, distilling or in certain foods, as is well known and is not further discussed herein.

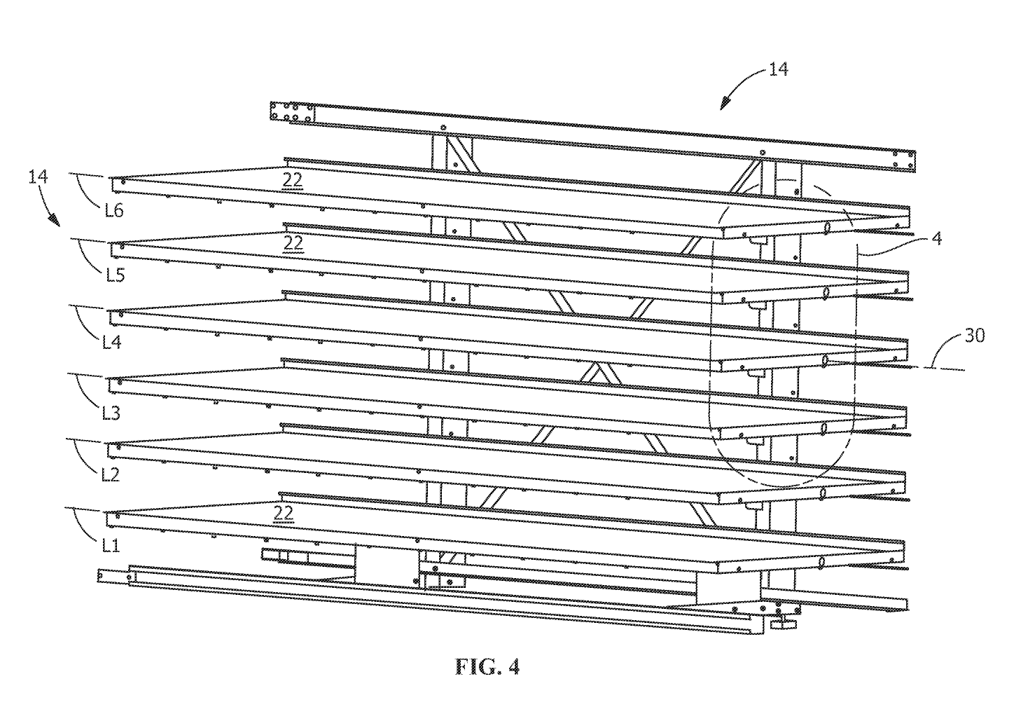

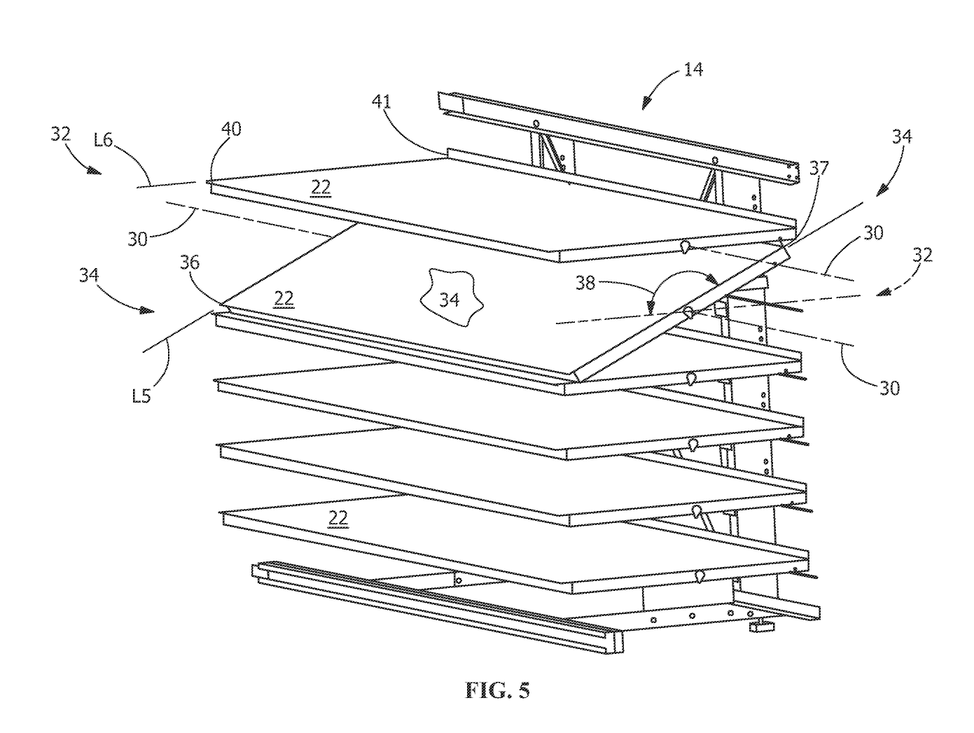

As shown in FIGS. 3 and 4, each sheet having a surface 22 (FIG. 4) is rotatably supported by a corresponding pair 28 of cantilevered frame portions 20 about an axis 30 extending along the longitudinal length of surface 22. As further shown in FIGS. 3 and 4, each surface 22 is arranged to correspond to six seed grain growing levels L1, L2, L3, L4, L5, L6. In another embodiment, a different number of surfaces and corresponding growing levels other than six growing levels may be utilized in the apparatus. As shown in FIG. 4, each surface 22 of the seed grain growing levels L1, L2, L3, L4, L5, L6 is arranged in a first position 32, which is substantially level. As further shown in FIG. 5, surface 22 corresponding with seed grain growing level L6 is arranged in a first position 32, while surface 22 corresponding with seed grain growing level L5 is urged into rotational movement 38 about axis 30 toward a second position 34. As a result of rotational movement 38 of surface 22 corresponding with seed grain growing level L5 toward second position 34, an end 36 of surface 22 corresponding with seed grain growing level L5 opposite frame 14 is urged to move away from an end 40 of surface 22 corresponding with seed grain growing level L6 that is maintained in first position 32. The magnitude of rotational movement 38 from substantially level first position 32 to second position 34 of surface 22 is sufficient such that tangled grain mass 26 is at least substantially removable from a corresponding surface moved from first position 32 to second position 34 due to the force of gravity acting on the tangled grain mass. The term at least substantially removable is intended to mean that a tangled grain mass supported by a surface arranged at the second position is removable from the surface with an application of at most a small removal force applied to the tangled grain mass in addition to gravity acting on the tangled grain mass, the term at least substantially removable including a removal force of zero or an absence of an additional removal force acting on the tangled grain mass, i.e., resulting in the mass sliding off the surface without assistance other than gravity acting upon the tangled grain mass. Since it should also be readily apparent to one having ordinary skill in the art that the construction of the apparatus of the present disclosure fails to impose surface length limitations, the term at least substantially removable may include the application of one or more small removal forces to remove the tangled grain mass from the surface in the second position. Provided to better understand the disclosure without being further limiting, a tangled grain mass can weigh hundreds of pounds, but such tangled grain mass may be removable from its supporting surface by application of one or more removal forces easily generated by an operator, such as that associated with manually grasping and pulling a portion of the tangled grain mass in a direction parallel to the surface and toward an end of the surface facing away from the frame of the apparatus.

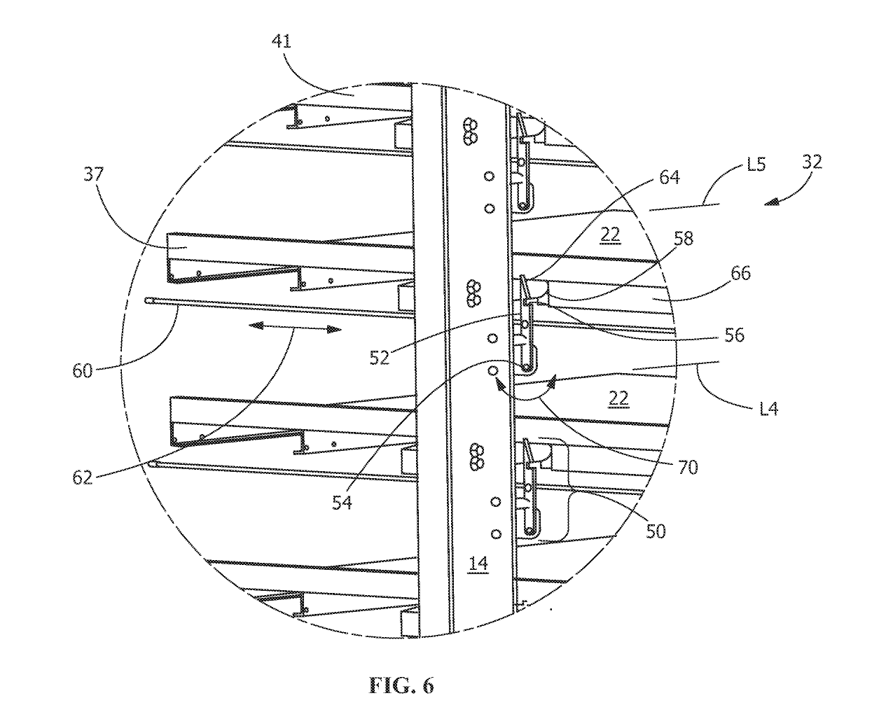

As shown in FIG. 6, which is a reverse, enlarged, partial upper perspective view taken from region 4 of FIG. 4, a retainer 50 includes a retaining member 52 having a pivotable connection 54 with frame 14. Retaining member 52 is connected to rod 60, having a notch formed there in, which retaining member 52 extending to a tapered portion 64 opposite pivotable connection 54. Notch 56 receives a tab 58 extending from sheet or surface 22 for selectively securing sheet or surface 22 in first position 32, such the sheet or surface 22 corresponding to seed grain growing level L5 in FIG. 6.

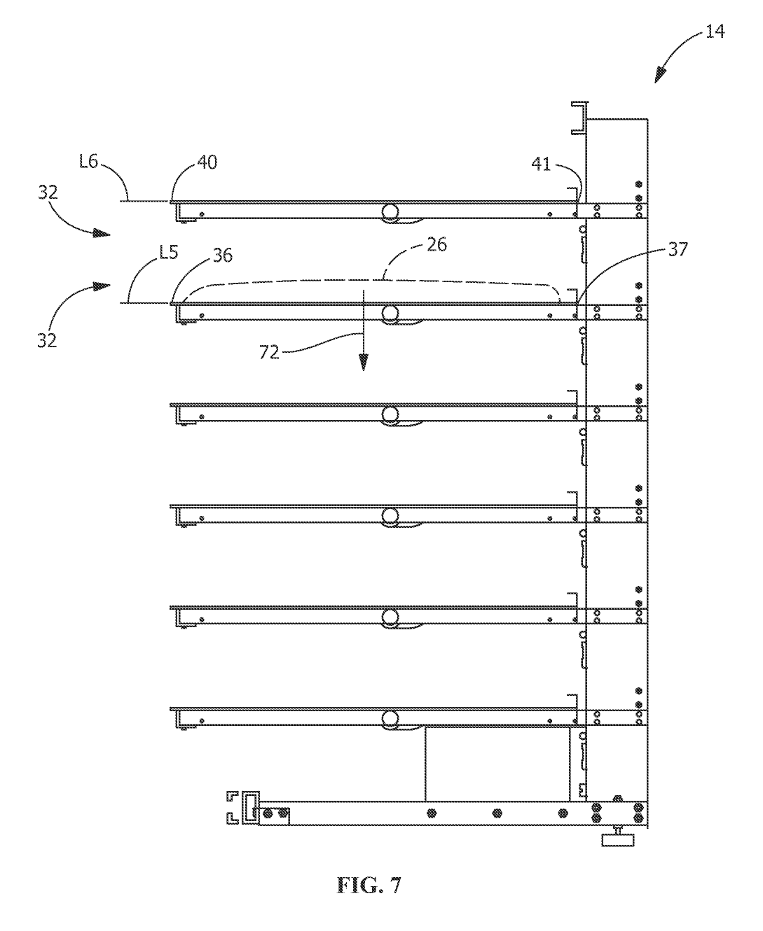

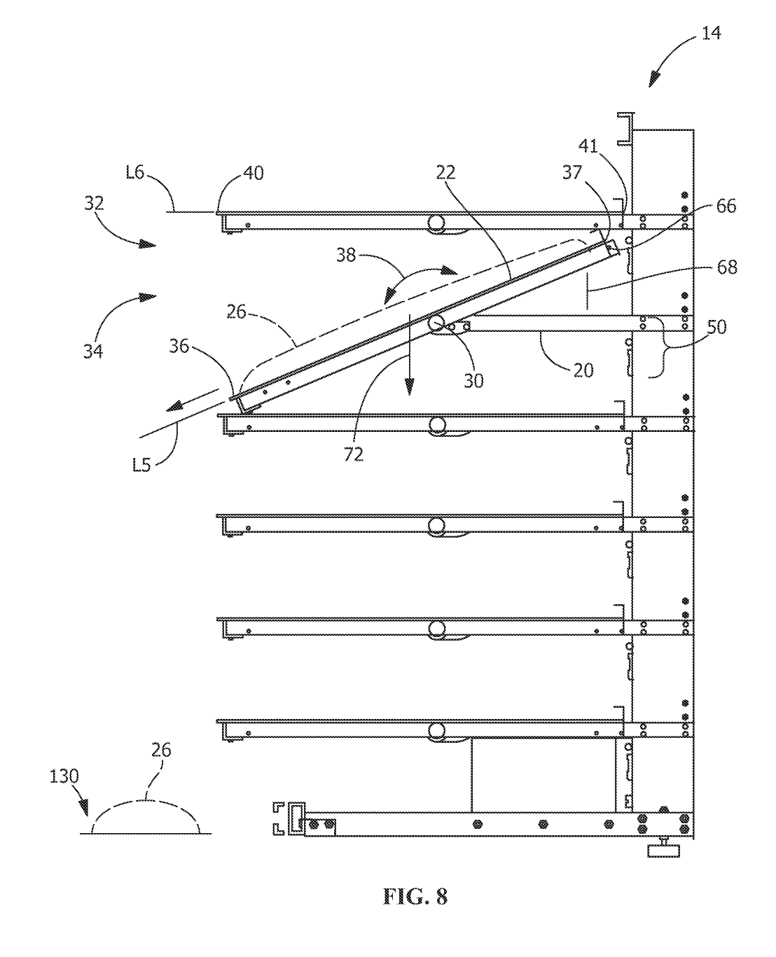

As collectively shown in FIGS. 6-8, once a sufficient predetermined period of time has passed to form tangled seed grain mass 26 (FIGS. 6 and 8) that is suitable for harvesting (i.e., to be removed from apparatus 10 (FIG. 1)), an operator (not shown) actuates rod 60 (FIG. 6) by temporarily applying a directed movement 62 in a direction such that rod 60 urges retaining member 52 into rotational movement 70 (FIG. 6) about pivotable connection 54 resulting in selectively disconnecting tab 58 from a corresponding sheet or surface 22. Subsequent to the selective disconnection between retaining member 52 and sheet or surface 22 corresponding to seed grain growing level L5 (FIG. 8), by virtue of the arrangement of pivot or rotational axis 30 relative to sheet or surface 22 and center of gravity 72 (FIGS. 7 and 8) of tangled seed grain mass 26 results in sheet or surface 22 being urged into rotational movement 38 about axis 30 in a direction from first position 32 (FIG. 7) to second position 34 (FIG. 8) by force of gravity.

Upon surface 22 reaching second position 34, tangled seed grain mass 26 is at least substantially removable therefrom as previously discussed. Once tangled seed grain mass 26 has been removed from surface 22, a counterweight 66 positioned near an end 37 opposite end 36 of surface 22 corresponding to seed grain growing level L5 of FIG. 8 applies a return force 68 for returning surface 22 from second position 34 to first position 32. In another embodiment, instead of a counterweight 66, a resilient member such as a spring or an actuator or other suitable device (not shown) may be used.

Returning to FIG. 6, subsequent to the temporary directed movement 62 of rod 60 for selectively disconnecting notch 56 of retaining member 52 from tab 58 of surface 22, permitting surface 22 to move from first position 32 to second position 34 as previously discussed, but prior to surface 22 returning from second position 34 to first position 32 as a result of return force 68, the temporary directed movement 62 is discontinued. As a result of discontinuing the temporary directed movement 62 in a direction pivotably urging notch 56 away from tab 58, retaining member 52 is permitted to return to its original position (i.e., the position prior to application of the temporary directed movement). Upon the return of surface 22 from second position 34 to first position 32, tab 58 slidably engages tapered portion 64 of retaining member 52 until tab 58 is again received in notch 56, thereby securing surface 22 in first position 32.

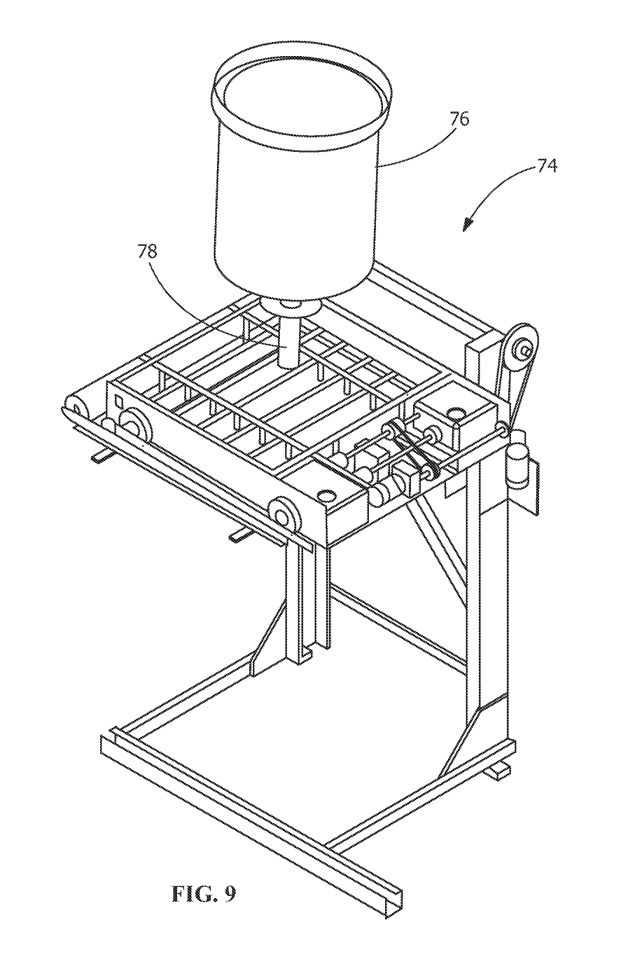

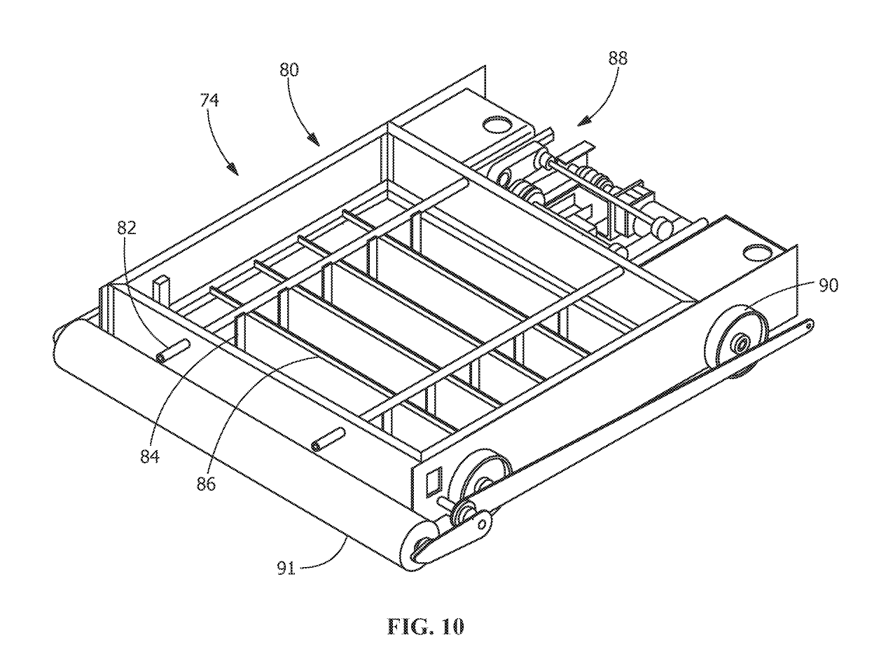

As shown in FIGS. 9 and 10, a seed deposition device 74 deposits a layer of seed grain onto each surface 22, which seed grain being received from a seed grain source 76 that may be partially or virtually entirely located exterior of an enclosure, such as semi-trailer 12 (FIG. 1). As further shown in FIG. 9, seed grain source 76 includes a seed delivery device 78, such as a tube that can be configured to deliver a predetermined amount of seed to seed deposition device 74. That is, seed delivery device 78 can be configured to prevent overfilling of seed deposition device 74. In one embodiment, seed delivery device 78 can include a metering device, such as a valve that can be selectively or automatically operated to selectively control delivery of seed grain as desired. As further shown in FIG. 10, seed deposition device 74 includes an agitator 80 having members 82, 84, 86 that may be driven by a motor 88 in one or more directions relative to seed deposition device 74 for providing improved distribution of seed grain. In one embodiment, seed deposition device 74 is self-propelled, such as by motor 88 movably driving one or more of wheels 90 and/or a reel 91, such as positioned in front of the seed deposition device. In one embodiment, wheels are positioned adjacent to opposed ends of each sheet or surface 22, such as opposed ends 40, 41 of the surface corresponding to seed grain growing level L6 of FIG. 8. In another embodiment, seed deposition device 74 may include a guide (not shown), such as for slidably engaging end 41, otherwise permitting unobstructed access over each of surfaces 22. In one embodiment, seed deposition device may be manually guided over a sheet or surface 22.

As a result of the cantilevered frame portions 20 (FIG. 3) extending outwardly from only one side of the frame 14 (FIG. 2), which frame portions 20 being pivotably or rotatably secured to the underside of the corresponding sheets or surfaces 22 (FIG. 8), seed deposition device 74, which moves over the upper or upwardly facing surface of each of the sheets or surfaces, is uniquely unobstructedly movable along the entire longitudinal length of frame 14 between opposed ends 16, 18 (FIG. 2). Unobstructed, as in unobstructedly movable, or the like, is defined as permitting continuous, unfettered movement and accessibility along and parallel to any portion of one or more of the sheets or surfaces along the entire longitudinal length of the sheets or surfaces, either individually or simultaneously, despite the surfaces being structurally pivotably movable relative to the frame surface, which is due to the cantilevered support by the frame from only one side (i.e., the ends of the sheets or surfaces not requiring and therefore lacking supports extending from the frame in other direction that would prevent such unfettered movement).

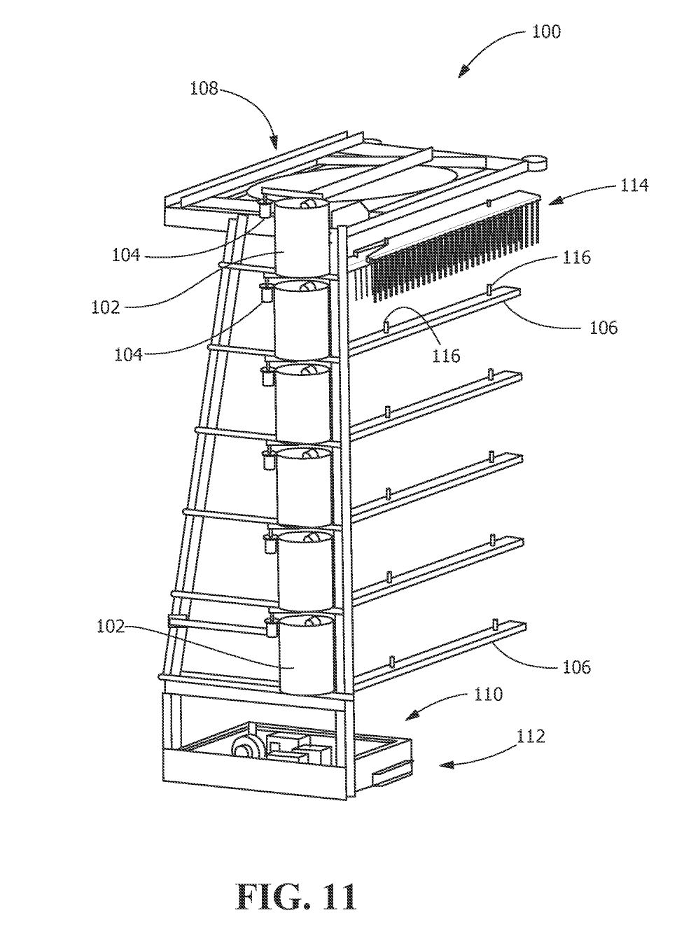

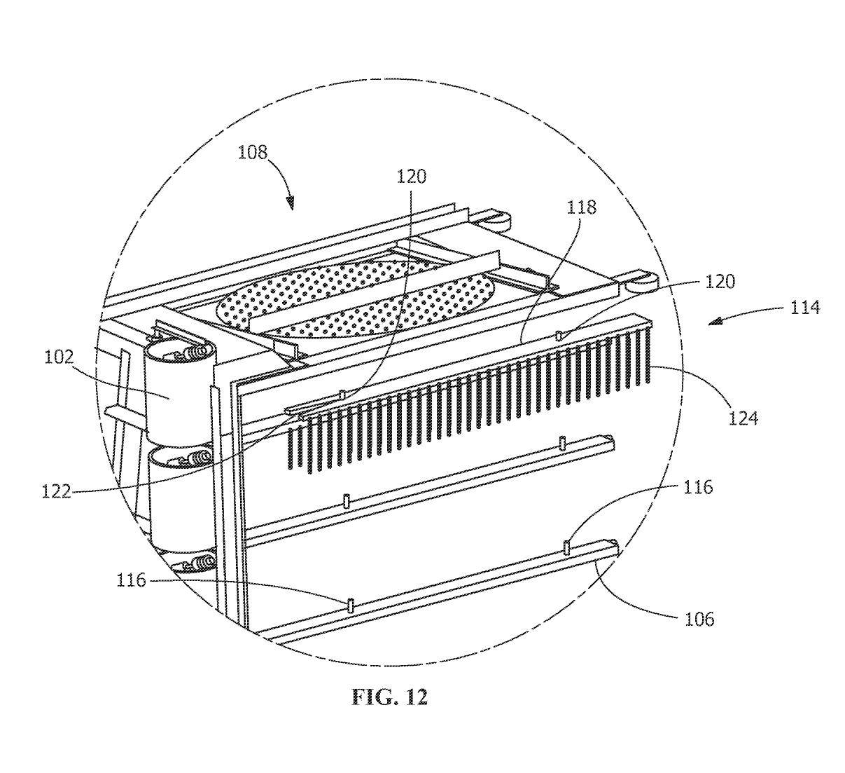

As shown in FIGS. 11 and 12, and for reasons as similarly previously discussed in regard to seed deposition device 74, a watering device 100 is unobstructedly movable between opposed ends 16, 18 of frame 14 for watering seed layers applied to (each of) sheets or surfaces 22. Watering device 100 includes a vessel or reservoir 102 for holding water, a valve 104, and a distributor 106 for selectively providing water from reservoir 102 via respective valve 104 and distributor 106 over seed grain layers 24 (FIG. 2) supported by each corresponding surface 22 (FIG. 2). In operation, distributors 106 collectively fixedly extend substantially transverse relative to the longitudinal length of sheets or surfaces 22, as watering device 100 unobstructedly moves along the longitudinal length of sheets or surfaces 22 between opposed ends 16, 18 of frame 14. In one embodiment, a water distribution control 108 may be used to provide a single, uniform distribution of water that is the same for each surface. In another embodiment, a controller 110 can provide independently controlled water distribution to each surface. As shown in FIG. 11, by virtue of a drive system 112, watering device 100 may be self-propelled. In another embodiment, the watering device may be movable by an operator (not shown) cooperatively with a water distribution control such that water is selectively provided to the seed grain layers. As a result of each reservoir being of shortened height, the pressure head associated with water distribution is sufficiently small such that “misting,” or entrainment of water droplets in the air stream is substantially prevented, greatly assisting in reducing humidity levels surrounding the apparatus as a result of operation of the watering device, resulting in less demand on dehumidification system 150 (FIG. 1).

As further shown in FIGS. 11 and 12, a rearrangement member 114 includes a body 118 in which are formed openings 120 configured to receive respective positioners 116 extending outwardly from corresponding distributors 106. Rearrangement member 114 is usable to simultaneously rearrange a layer of seed grain while water is being applied to that layer of seed grain. As further shown in FIG. 12, one opening 120 corresponds with a V-shaped slot 122 ease of installation and removal of rearrangement member 114. As further shown in FIG. 12, a plurality of fingers or protrusions 124 extend outwardly from body 118 of rearrangement member 114. As a result of protrusions 124, the ability to simultaneously rearrange a seed layer while watering, permits the thickness of the seed layer to the increased. Previously, the maximum thickness or thickness of seed layers that could be applied onto a sheet or surface was limited, thereby resulting in a reduced harvest, due to the inability to provide sufficient moisture to the seed grain during early stages of sprouted growth of the seed grain. Surprisingly, by virtue of simultaneously rearranging the seed layer during watering, such as by using rearrangement member 114, the thickness of the applied seed layer can be increased while continuing to provide sufficient moisture. In another embodiment other rearrangement constructions, such as one or more protrusions independently movable relative to the watering device may be used.

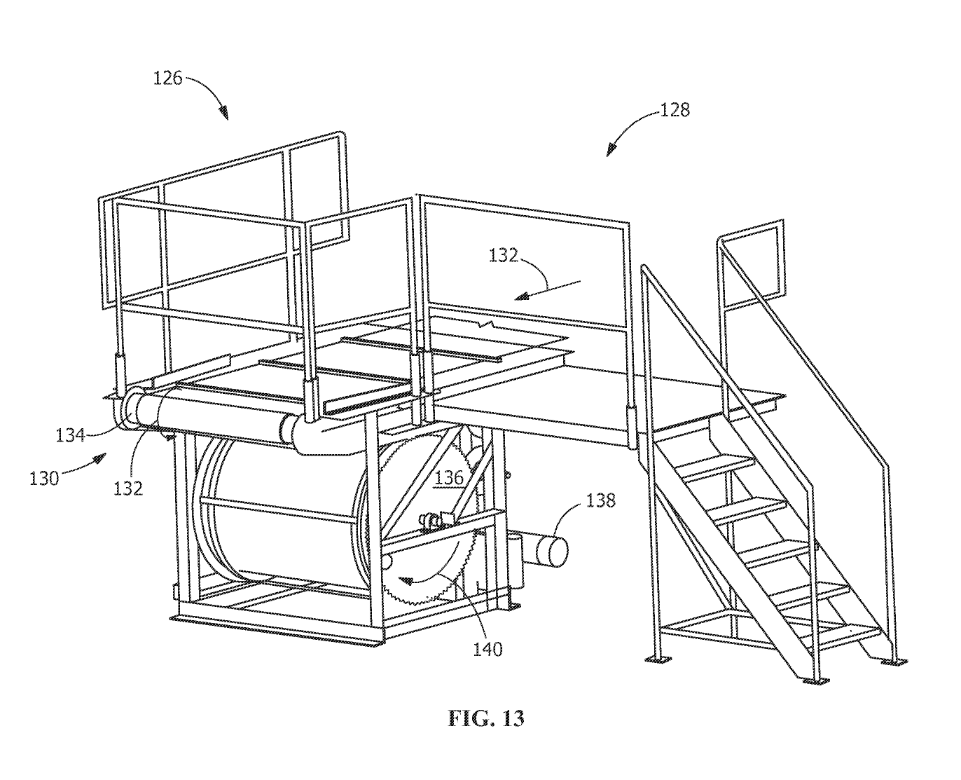

As shown in FIGS. 1, 8 and 13, an evacuator 126 removes tangled seed grain mass 26 subsequent to removal of a tangled seed grain mass from a corresponding sheet or surface 22 arranged in a second position 34. That is, an evacuator 126 removes tangled seed grain mass 26 that has fallen from sheet or surface 22 onto a conveyor 130 (FIG. 8), also referred to as an apron. As further shown in FIG. 13, evacuator 126 includes a platform 128, such as for permitting access to semi-trailer 12 (FIG. 1). As shown in FIG. 13, evacuator 126 further includes a reel 136 that is urged into directed rotational movement 140 by a drive source 138, such as a motor. In response to tangled seed grain mass 26 falling onto conveyor 130, drive source 138 urges reel 136 into directed rotational movement 140 such that conveyor 130 is urged into driven movement 132 away from sheet or surface 22 and toward evacuator 126. That is, conveyor 130 of evacuator 126 carries tangled seed grain mass 26 away from sheet or surface 22 of the apparatus. Stated another way, as a result of continued directed rotational movement 140 of reel 136, conveyor 130 is urged into driven movement 132 onto evacuator 126 and around a roller 134 such that conveyor 130 is collected by reel 136. Tangled seed grain mass 26 that is carried by conveyor 130 is deposited in a collector 142 (FIG. 1), which can be a stationary collection container or a scoop of a skid loader or other implement for transporting tangled seed grain mass 26 as needed.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An apparatus for growing and harvesting a tangled mass composed of sprouted seed grain, comprising:
a plurality of overlying substantially planar surfaces having a length, the length being capable of continuously extending at least a length of a semi-trailer, each surface being independently rotatably connected to an immobile frame, each surface rotatable between a first position and a second position, each surface configured to receive a layer of seed grain that is permitted to grow for a predetermined period of time on each surface in the first position, the layer of seed grain becoming a continuous tangled mass of sprouted seed grain;
wherein each rotatable surface is rotatable about an axis extending along the length of the surface;
wherein the frame includes cantilevered frame portions, each frame portion extends outwardly from the frame and beneath the corresponding surface to a rotatable connection positioned on an underside of the corresponding surface along the axis, the frame portion being perpendicular to the axis;
wherein upon rotation of a surface of the plurality of surfaces to the second position after the predetermined period of time, the mass associated with the surface is at least substantially removable from the rotated surface due to gravity.

2. (canceled)

3. The apparatus of claim 1, wherein the axis is positioned such that a retainer is selectively connected to each surface to maintain each surface in the first position, wherein selectively disconnecting the retainer from its corresponding surface results in the corresponding surface rotating about the axis from the first position toward the second position.

4. The apparatus of claim 3, wherein subsequent to removal of the mass from the corresponding surface at the second position, each surface is subjectable to a return force for urging the corresponding surface to rotate from the second position toward the first position for connecting the corresponding surface and its retainer.

5. (canceled)

6. The apparatus of claim 1, wherein the apparatus further comprises an evacuator for removing the mass from the apparatus, the evacuator including a conveyor for receiving the mass removed from its corresponding surface in the second position, the conveyor urged by a drive source to carry the mass away from the apparatus.

7. The apparatus claim 1, wherein the apparatus further comprises a seed deposition device for depositing the layer of seed grain onto each surface, the seed deposition device unobstructedly movable between opposed ends of the length of each surface.

8. The apparatus claim 7, wherein the seed deposition device is self-propelled.

9. The apparatus of claim 1, wherein the apparatus further comprises a watering device having a support structure unobstructedly movable along a side of the surface opposite the frame between opposed ends of the length of each surface, the watering device including a reservoir and distributor for each surface for controllably applying water at a sufficiently low pressure onto each layer of seed grain such that applied water is substantially prevented from forming a mist, each distributor is cantilevered from the support structure and extends over an entire width of a corresponding surface.

10. The apparatus of claim 9, wherein the water device is self-propelled.

11. The apparatus of claim 9, wherein the watering device includes a rearrangement member having a plurality of protrusions for simultaneously rearranging the layer of seed grain while water is applied to the layer of seed grain.

12. The apparatus of claim 11, wherein the rearrangement member is selectively removable from the watering device.

13. The apparatus of claim 1, wherein the apparatus is contained inside the semi-trailer.

14. The apparatus of claim 13, wherein the semi-trailer is a refrigerated trailer.

15. The apparatus of claim 7, wherein the seed deposition device includes an agitator.

16. The apparatus of claim 1, wherein the predetermined period of time is sufficient for the facilitation of malting.

17. A method for growing and harvesting a mass composed of sprouted seed grain, comprising:
providing a device as claimed in claim 1;
depositing a layer of seed grain onto each surface;
controllably applying water onto each layer of seed grain; and
removing from the device each mass removed from its corresponding surface in the second position.

18. The method of claim 17, wherein controllably applying water to each layer of seed grain includes controllably applying water onto each layer of seed grain such that applied water is substantially prevented from forming a mist.

19. The method of claim 17, comprising simultaneously rearranging the layer of seed grain with a rearrangement member while water is applied to the layer of seed grain.

20. An apparatus for growing and harvesting a tangled mass composed of sprouted seed grain, comprising:
a plurality of overlying substantially planar surfaces having a length, the length being capable of continuously extending at least a length of a semi-trailer, each surface being independently rotatably connected to an immobile frame, each movable surface is rotatable about an axis extending along the length of the surface between a first position and a second position, each surface configured to receive a layer of seed grain that is permitted to grow for a predetermined period of time on each surface in the first position, the layer of seed grain becoming a continuous tangled mass of sprouted seed grain;
wherein each rotatable surface is rotatable about an axis extending along the length of the surface;
wherein the frame includes cantilevered frame portions, each frame portion extends outwardly from the frame and beneath the corresponding surface to a rotatable connection positioned on an underside of the corresponding surface along the axis, the frame portion being perpendicular to the axis;
wherein the apparatus includes a watering device having a support structure unobstructedly movable along a side of the surface opposite the frame between opposed ends of the length of each surface, the watering device including a reservoir and distributor for each surface for controllably applying water at a sufficiently low pressure onto each layer of seed grain such that applied water is substantially prevented from forming a mist, each distributor is cantilevered from the support structure and extends over an entire width of a corresponding surface;
wherein the watering device includes a rearrangement member having a plurality of protrusions for simultaneously rearranging the layer of seed grain while water is applied to the layer of seed grain;
wherein upon rotation of a surface of the plurality of surfaces to the second position after the predetermined period of time, the mass associated with the surface is at least substantially removable from the rotated surface due to gravity.
